(19) United States
(12) Patent Application Publication
(10) Pub. No.: US 2010/0018834 A1
(43) Pub. Date: Jan. 28, 2010

(54) Cooling Bed Plate

(75) Inventor: Darryl R. Wendt, Davisburg, MI (US)

Correspondence Address: BROOKS KUSHMAN P.C., 1000 TOWN CENTER, TWENTY-SECOND FLOOR, SOUTHFIELD, MI, 48075, US

(73) Assignee: ALLOR MANUFACTURING INC., Brighton, MI (US)

(21) Appl. No.: 12/179,919

(22) Filed: Jul. 25, 2008

(51) Int. Cl. B21B 43/04; B65G 13/00; B65G 39/12

(52) U.S. Cl. 193/35 R

(57) ABSTRACT

A cooling bed plate is formed of a plurality of generally parallel transverse members, at least two longitudinal side rails forming a rigid plate having a series of transverse open cooling slots extending therethrough. The upper plane of the rigid plate has a series of recessed pockets formed therein with transversely spaced apart support blocks welded to spaced apart transverse members. The bearing blocks are removably affixed to the support blocks for supporting rollers mounted within the recess pockets for rotation about a generally transverse axis to support an object to be cooled thereabove.

### BACKGROUND OF THE INVENTION

1. Field of the Invention The present invention relates to cooling bed plates and more particularly, to cooling bed plates having a roller insert for supporting a heated object during cooling.

2. Background Art

Cooling bed plates are typically used in foundries and steel mills for supporting large, heavy billets or castings as they cool. Historically, cooling bed plates were large, heavy grids made up of a series of longitudinal rail members with interconnecting transverse members providing structure. Large billets to be cooled were placed on the cooling bed plates. In order to move the billets, they would either have to be lifted or skid across the grid surface.

There have been numerous efforts over the years to provide cooling bed plates with rollers so that objects can be transferred across an aligned series of cooling bed plates. The manufacturing of cooling bed plates having rollers is not a simple nor easy task. The roller assemblies must be capable of withstanding high loads and high temperatures in a steel mill. It is not uncommon to place steel billets on a cooling bed plate while the steel is in the 1400° F. range. These high temperatures cause corrosion and lubrication problems for the rollers and associated bearings. When the cooling bed plate is used to support ferrous materials such as steel, it is common to lift the cooled steel billets off of the cooling bed plate using a magnetic crane. The rollers, if formed of a magnetic material, tend to lift with the magnet necessitating that the rollers be physically constrained in a vertical direction.

Suppliers in the past have manufactured roller insert assemblies for use in retro fitting cooling bed plates not initially provided with rollers. These systems tend to be complex, cumbersome and are susceptible to heat induced corrosion. It is an object of the present invention to provide a simple, reliable, low cost roller insert for cooling bed plates.

### SUMMARY OF THE INVENTION

A cooling bed plate for use of practicing the present invention is made up of a series of generally parallel spaced apart transverse members and at least two spaced apart longitudinal side rails affixed to the transverse members to form a rigid plate having a series of transverse open cooling slots to facilitate the cooling of an object placed thereabove. The upper surface of the rigid plate defines an upper plank having a plurality of reserved pockets formed therein by forming notches in one or more adjacent transverse members. Within each pocket, a pair of longitudinally extending transversely spaced apart support blocks are securely welded to at least two transverse members. Associated with each pair of support blocks in the recessed pockets are a pair of transversely spaced apart bearing blocks or removably attachable to the support blocks for pivotally supporting a roller spanning therebetween. The rollers are generally spaced apart and define a series of transversely spaced apart roller axes. The uppermost surface of the rollers collectively define a planar support surface generally spaced above the upper plane of the rigid plate.

In the preferred embodiment of the invention, the cooling bed plate further includes a series of skid bars mounted on the upper plane of the rigid plate in a transversely spaced apart manner. The skid bars have upper surfaces which collectively define a skid plane which lies above the upper plane of the rigid plate and below the support plane defined by the rollers.

### BRIEF DESCRIPTION OF THE DRAWINGS

FIG. 1 is a top plan view of a cooling bed plate of the present invention with an object shown in phantom outline positioned thereupon;

FIG. 2 is a cross-section taken along a longitudinal axis illustrating the recessed pocket in the location of the support block;

FIG. 3 is a transverse cross-section illustrating the recessed pocket and the position of the support blocks relative to the notch in the transverse member;

FIG. 4 is a longitudinal cross-section corresponding to FIG. 2 with the bearing block and roller installed; and

FIG. 5 is a transverse cross-section similar to FIG. 3 with the roller and bearing blocks installed illustrating the relative position of the upper plane of the rigid plate, the skid plane and the planar support surface defined by the rollers.

### DETAILED DESCRIPTION OF THE PREFERRED EMBODIMENT(S)

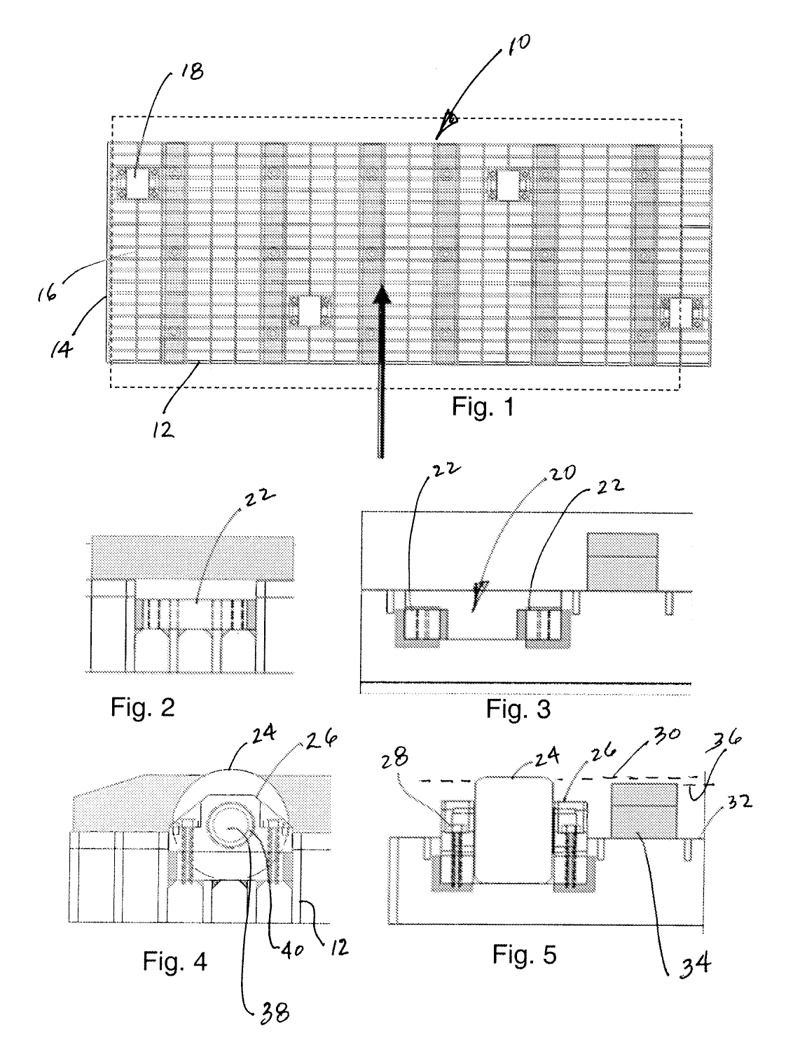

A cooling bed plate 10 is illustrated in top plan view in FIG. 1. The cooling bed plate is made up on a plurality of transversely extending transverse members 12 spanning between a pair of spaced apart longitudinally extending side members 14. In the preferred embodiment, a series of intermediate longitudinal members 16 are positioned between right and left side members 14. As illustrated, the intermediate longitudinal members have a reduced height when compared to transverse members 12 and are received within a series of notches formed in the upper edge of transverse members 12 and are welded together to form a rigid plate having an open grid like structure. A series of roller assemblies 18 are mounted on the rigid plate positioned within recess pockets 20 formed within the upper plane of the rigid plate by a series of pockets 20 cut into one or more adjacent transverse members. Pockets 20 are further preferably defined by fore and aft adjacent transverse members, adjacent to the notched members. Within each of the pockets, a pair of longitudinally extending spaced apart support blocks 22 are located each securely welded to at least two spaced apart transverse members as illustrated in FIGS. 2 and 3. Preferably, each of the support blocks is welded to two or more notched transverse members and the fore and aft adjacent unnotched transverse members as illustrated in FIGS. 2 and 3.

As further illustrated in FIGS. 2 and 3, each of the support blocks is provided with spaced apart apertures sized to receive fasteners. In the embodiment illustrated, the apertures are threaded for receiving a correspondingly threaded bolt. Alternatively, these threaded apertures can receive a stud or the apertures could be unthreaded and a through bolt and corresponding nut could be used. In the preferred embodiment illustrated, the support blocks are welded to the transverse members at numerous locations, however, one could omit welds at one or more of the illustrated locations provided adequate strength was achieved by the remaining welds without departing from the present invention.

FIGS. 5 and 6 correspond to FIGS. 2 and 3, however, rollers 24 are installed between bearing blocks 26. Bearing blocks 26 each mount on a spaced apart support blocks 22. The bearing blocks each have a pair of spaced apart generally vertical bores extending therethrough for receiving bolts for affixing the bearing blocks to the underlying support blocks 22. Bolts 28 can alternatively be replaced by other types of fasteners such as a stud extending from the support block with a nut for clamping the bearing block to the support block. Alternatively, as previously mentioned, through bolts could be used with corresponding nuts located below the support block 22.

The uppermost surface of the rollers 24 collectively define a planar support surface 30 spaced above the upper plane 32 of the rigid plate. Preferably, the cooling bed plate 10 is further provided with a plurality of generally parallel transversely spaced apart skid bars 34 mounted on the upper plane 32 of the rigid plate. These skid bars each have an upper surface which collectively define a skid plane 36 which lies between the upper plane 32 of the rigid plate and the support plane 30 defined by the rollers. The skid bars are preferably formed of high temperature steel and are capable of supporting the object to be cooled in the event of a roller failure. Ideally, each of the rollers 24 is made of a cylindrical roller wheel and a central axle 38. Preferably, each end of the central axle is supported by roller bearings 40 located in each of the bearing blocks 26. Preferably, roller bearings 40 have an operating range of 0° to 1000° F. Again, the roller bearings like the skid bars and rollers should be formed of a material capable of withstanding the high temperatures reached when cooling the hot object to be processed.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention. For example, the transversely spaced apart support blocks may be part of a subassembly having one or more cross members interconnecting the spaced apart bearing blocks to form a generally rectangular insert which can be more easily handled and positioned within the pocket during welding. Alternatively, the two spaced apart bearing blocks could be formed as a rectangular member from a single billet, however, this alternative results in high scrap rate and while not preferred, describes one of several alternative variations on the claimed invention which would be readily apparent to one of skilled in the art.

What is claimed is:

1. A cooling bed plate comprising:
a plurality of generally parallel spaced apart transverse members;
at least two spaced apart longitudinal side rails affixed to the transverse members to form a rigid plate having a plurality of open transverse cooling slots to facilitate cooling of a hot object placed there above, the upper surface of the rigid plate defining an upper plane;
wherein the upper plane of the rigid plate is provided with a plurality of recessed pockets formed in part by notches in one or more adjacent transverse members and the fore and aft adjacent transverse members;
a pair of longitudinally extending transversely spaced apart support blocks positioned within each of the plurality of recessed pockets and each securely welded to at least two spaced apart transverse members;
a pair of transversely spaced bearing blocks removably attachable to each of the pairs of support blocks; and
a plurality of rollers each pivotally mounted to a pair of bearing blocks for rotation about a series of longitudinally spaced apart generally transverse roller axes, with the uppermost surface of the rollers defining a generally planar support surface spaced above the upper plane of the rigid plate.

2. The cooling bed plate of claim 1 further comprising a plurality of generally parallel transversely spaced apart skid bars mounted on the upper plane of the rigid plate, the skid bars having an upper surface which collectively provide a skid plane surface which lies between the rigid plate upper plane and the planar support surface defined by the rollers.

3. The cooling bed plate of claim 1 wherein the recessed pockets are each formed by notches in two or more adjacent transverse members.

4. The cooling bed plate of claim 1 wherein the support blocks are each have a pair of longitudinally spaced apart apertures formed therein for receiving fasteners for attaching the bearing blocks.

5. The cooling bed plate of claim 1 wherein the plurality of rollers further comprise an roller axle shaft and the bearing blocks are further provided with a roller bearing assembly for pivotably supporting an end of the roller axle shaft.

6. A cooling bed plate comprising:
a plurality of generally parallel spaced apart transverse members;
at least two spaced apart longitudinal side rails affixed to the transverse members to form a rigid plate having a plurality of open transverse cooling slots to facilitate cooling of a hot object placed there above, the upper surface of the rigid plate defining an upper plane;
wherein the upper plane of the rigid plate is provided with a plurality of recessed pockets formed in part by notches in two or more adjacent transverse members and the fore and aft adjacent transverse members;
a pair of longitudinally extending transversely spaced apart support blocks positioned within each of the plurality of recessed pockets and each securely welded to at least two spaced apart transverse members;
a pair of transversely spaced bearing blocks removably attachable to each of the pairs of support blocks;
a plurality of rollers each pivotally mounted to a pair of bearing blocks for rotation about a series of longitudinally spaced apart generally transverse roller axes, with the uppermost surface of the rollers defining a generally planar support surface spaced above the upper plane of the rigid plate; and
a plurality of generally parallel transversely spaced apart skid bars mounted on the upper plane of the rigid plate, the skid bars having an upper surface which collectively provide a skid plane surface which lies between the rigid plate upper plane and the planar support surface defined by the rollers.

7. The cooling bed plate of claim 6 wherein the support blocks are each have a pair of longitudinally spaced apart apertures formed therein for receiving fasteners for attaching the bearing blocks.

8. The cooling bed plate of claim 6 wherein the plurality of rollers further comprise an roller axle shaft and the bearing blocks are further provided with a roller bearing assembly for pivotably supporting an end of the roller axle shaft.
